(19) United States
(12) Patent Application Publication
(10) Pub. No.: US 2025/0342723 A1
(43) Pub. Date: Nov. 6, 2025

(54) Photometric Stereo Enrollment for Gaze Tracking

(71) Applicant: Apple Inc., Cupertino, CA (US)

(72) Inventors: Lionel E Edwin, San Jose, CA (US); Tomi P Maila, San Jose, CA (US); Martin Haller, Mountain View, CA (US); Tom Sengelaub, Oakland, CA (US)

(73) Assignee: Apple Inc., Cupertino, CA (US)

(21) Appl. No.: 19/183,621

(22) Filed: Apr. 18, 2025

Related U.S. Application Data
(60) Provisional application No. 63/642,302, filed on May 3, 2024.

(51) Int. Cl. G06V 40/19; G06T 7/20; G06T 7/73; G06V 10/141; G06V 40/60

(52) U.S. Cl. CPC G06V 40/19; G06T 7/20; G06T 7/73; G06V 10/141; G06V 40/67; G06T 2207/30201

(57) ABSTRACT

Photometric stereo techniques enable using a single camera to perform an enrollment process for creating a user-specific anatomical model of an eye for gaze tracking. The user-specific anatomical model includes information about a user's center of vision at multiple dilation states of the eye, which can be used to enhance the accuracy of gaze tracking techniques. Accurate gaze tracking techniques enable the use of gaze tracking at close range, for example, gaze tracking within a head-mounted display device.

### PRIORITY CLAIM

This application claims benefit of priority to U.S. Provisional Application Ser. No. 63/642,302, entitled “Photometric Stereo Enrollment for Gaze Tracking,” May 3, 2024, which is incorporated herein by reference in its entirety.

### BACKGROUND

### Technical Field

This disclosure relates generally to modeling the eye for use in performing gaze tracking, including generating an anatomically based gaze-dilation relationship estimation for a particular eye.

### Description of the Related Art

Gaze tracking is the process of monitoring an eye to determine the direction of the eye's vision, also called gaze. The location of the pupil can provide an approximate gaze tracking. Purkinje images, also called glints, can provide a means for a gaze tracking system to track movement of the pupil.

The center of vision of an eye is based on the macula, a dense collection of rods and cones in the retina. The retina is internal to the eye, and thus the location of the macula is difficult to observe directly. The specific anatomical relationship of the macula to visibly observable portions of the eye, such as the iris and pupil, may vary between eyes and may change in relation to movements of the eye.

Photometric stereo techniques enable three-dimensional (3D) information about an object to be obtained by a single camera. Photometric stereo techniques involve varying the position of illumination directed towards an object to determine 3D information of the object, such as surface normals, without requiring a change of the relative positions of the object and camera.

### SUMMARY

A gaze tracking system that uses anatomical information about a specific eye can achieve a higher degree of accuracy in gaze tracking based on external observation of an eye than a gaze tracking system that does not use anatomical information. The gaze tracking system may use photometric stereo techniques to obtain the anatomical information, for example, structure data of the iris-pupil edge at multiple dilation states of the eye, with a single camera. A gaze tracking system in a head-mounted device that has limited space for eye-monitoring sensors, for example, a glasses-type head-mounted display device, may be able to obtain anatomical information through photometric stereo techniques to enable gaze tracking with a high degree of accuracy.

A gaze tracking system that does not use anatomical information about a specific eye may use the center of the pupil as an approximate location for the center of vision. However, the pupil is a light-transparent region of the exterior of the eye and does not define the center of vision of the eye. The center of vision of an eye is defined by the location of the macula, which may change location relative to the center of the pupil at various dilation states of the eye and poses of the eye. The specific location of the macula relative to the center of the pupil may not be consistent between specific eyes. A gaze tracking system may use an eye-specific anatomical model at various dilation states and poses of the eye with known directions of center of vision to achieve a high degree of accuracy in gaze tracking. An eye-specific anatomical model may include information about the iris-pupil edge, the pose and dilation of the eye, and a known direction of vision.

Photometric stereo techniques, for example, varying the locations of light sources illuminating an object without varying the direction from which the object is photographed, enable the discovery of structural information about an object from a single camera. A gaze tracking system that has limitations on the space and positions available for sensors and illumination elements may only have a single camera available to obtain information about an eye. For example, a gaze tracking system in a head-mounted display device with a small frame, such as a pair of glasses, may have limited space for cameras, illumination elements, and computing devices such as controllers. The cameras and illumination elements may use visible or non-visible light, for example, infrared or near-infrared light. An illumination element, also called a light source, may occupy less space in a frame than a camera and may have fewer placement restraints than a camera. The limited frame space may be better used by placing a single camera per eye and multiple light sources as opposed to placing multiple cameras and one or multiple light sources per eye.

Additionally, for a system installed in a glasses-type head-mounted device, the frame of a pair of glasses may impose limitations on the placement of the camera and illumination elements. The camera and illumination elements may be restricted to locations that are close to the eye and at a sharp angle to the eye, for example, at the frame of a pair of glasses while the glasses are worn by a user. The restricted placement of the camera and illumination elements may restrict a gaze tracking system's use of traditional gaze tracking techniques. For example, the technique of bright pupil infrared or near-infrared is achieved with illumination directly through the pupil, whereas in a pair of glasses worn by a user, a lens of the glasses may occupy the position where an illumination element would be located for bright pupil infrared or near-infrared gaze tracking. Similarly, the restricted location of illumination elements may restrict the gaze tracking system's use of the infrared or near-infrared “glint” technique that tracks Purkinje images, which are sometimes called glints, which are reflections of light that have been reflected by structural elements of the cornea and lens of the eye. Additionally, the restricted location of the camera may cause glints to be obscured from the camera, for example, by eyelashes or a portion of the face surrounding the eye.

Due to structural restrictions of a glasses-type head-mounted device, traditional gaze tracking techniques may be limited. A gaze tracking system in a glasses-type device may use gaze tracking techniques which require minimal equipment and can be done with equipment that is at close-range and at steep angles to the eye. Such techniques may include photometric stereo techniques, as described herein for use by a gaze tracking enrollment system for gaze tracking enrollment. Gaze tracking enrollment may include obtaining structural information, for example, information about the iris-pupil boundary which a gaze-tracking system may use to generate an iris-pupil edge model for various poses and dilation states of the eye.

### BRIEF DESCRIPTION OF THE DRAWINGS

FIG. 1A illustrates a photometric stereo enrollment system at four illumination configurations, according to some embodiments.

FIG. 1B is a side view of the photometric stereo enrollment system at a first illumination configuration, according to some embodiments.

FIG. 1C is the side view of the photometric stereo enrollment system at a second illumination configuration, according to some embodiments.

FIG. 2A illustrates an iris-pupil boundary with a known center of vision for a first dilation state of an eye, according to some embodiments.

FIG. 2B illustrates an iris-pupil boundary with a known center of vision for a second dilation state of an eye, according to some embodiments.

FIG. 3A illustrates the combination of the structural data of the eye contained in FIGS. 2A and 2B, according to some embodiments.

FIG. 3B is an iris-pupil edge model based on the structural data illustrated in FIG. 3A, according to some embodiments.

FIG. 4 is an iris-pupil edge model chart containing information that is shown visually in FIG. 3B, according to some embodiments.

FIG. 5A is a user view of a transparent lens for display, which displays an indicator for use during photometric stereo enrollment, according to some embodiments.

FIG. 5B is a user view of the transparent lens displaying a second indicator for use during photometric stereo enrollment, according to some embodiments.

FIG. 5C is a user view of an environment the user can see during enrollment, according to some embodiments.

FIG. 5D is a user view of the environment as seen through the transparent lens, which displays an indicator associated with the environment, according to some embodiments.

FIG. 6A is an illustration of the cornea during near-view focus, according to some embodiments.

FIG. 6B is an illustration of the cornea during far-view focus, according to some embodiments.

FIG. 7A is a side view of a headset-type device with a transparent lens at a first point in time, such as before a controllable tint of the transparent lens is increased, according to some embodiments.

FIG. 7B is the side view of the headset-type device with the transparent lens at a second point in time, such as after the controllable tint of the transparent lens is increased, according to some embodiments.

FIG. 8A is a front view of a glasses-type head-mounted display device, according to some embodiments.

FIG. 8B is a back view of a glasses-type head-mounted display device, according to some embodiments.

FIG. 8C is a side view of a glasses-type head-mounted display device, according to some embodiments.

FIG. 9A is a front view of a headset-type head-mounted display device, according to some embodiments.

FIG. 9B is a back view of a headset-type head-mounted display device, according to some embodiments.

FIG. 9C is a side view of a headset-type head-mounted display device, according to some embodiments.

FIG. 10A is a timeline of a burst image capture, according to some embodiments.

FIG. 10B illustrates region of interest calibration, according to some embodiments.

FIG. 11 is a flowchart illustrating a method of performing gaze-tracking enrollment, according to some embodiments.

FIG. 12 is a block diagram illustrating an example computing device that may be used, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### DETAILED DESCRIPTION

A gaze tracking system can achieve a higher degree of accuracy by obtaining structural data about the eye during an initial enrollment process. The externally observable portions of the eye, such as the iris-pupil boundary, may change position relative to the internal portion of the eye, such as the macula, as the eye undergoes changes in shape, for example, from changing dilation states or moving to a particular pose.

A portion of the process used by the gaze tracking enrollment system may include displaying indicators to indicate to the user where to direct the center of vision of the user's eye. The gaze tracking enrollment system may use illumination configurations with a set amount of light to cause the eye to have a particular dilation state while the gaze tracking enrollment system uses photometric stereo techniques to obtain structure data about the eye with the known direction of vision and known dilation state, including information about the cornea and the iris-pupil boundary of the eye. The gaze tracking enrollment system may change the location of the indicator and the amount of light used in order to obtain additional structure data for use in gaze tracking with the particular eye.

The gaze tracking enrollment system may generate an iris-pupil boundary model with the obtained structure data of the eye. A gaze tracking system, which may include the gaze tracking enrollment system, may use the generated iris-pupil boundary model in later gaze tracking processes to increase the accuracy of gaze tracking. For a gaze tracking system in a device such as a head-mounted display, the display may be close to the eye, and a high degree of accuracy in gaze tracking may be needed to identify the portion of the display to which the center of vision of the eye is directed.

In some embodiments, the gaze tracking enrollment system may be included in a head-mounted display device, for example, a glasses-type head-mounted display device. The gaze tracking enrollment system may use a controllable tint of transparent lenses of the head-mounted display device to limit the amount of uncontrolled ambient light that is present during the enrollment process.

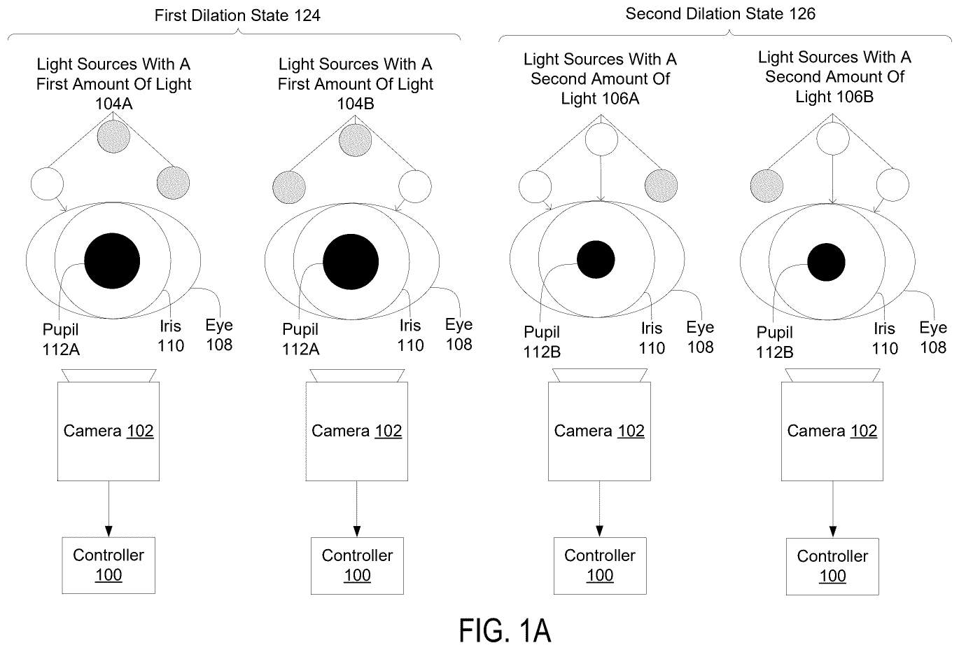

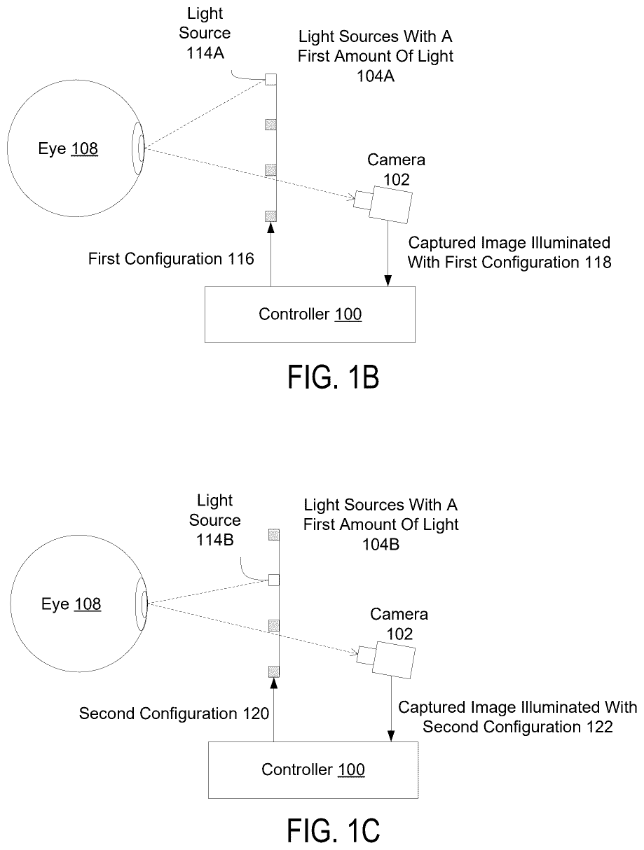

FIG. 1A illustrates a photometric stereo enrollment system at four illumination configurations, according to some embodiments.

Four instances of a camera 102 directed to an eye 108 are shown in FIG. 1A. The illustrated eyes are the same eye across different, non-specific moments in time. A set of light sources may be configured to illuminate the eye 108 such that light is reflected from the eye to the camera 102. The light sources may emit visible light, or invisible light, such as infrared or near-infrared light. Although three light sources are included in each of the four shown sets of light sources, a different number and configuration of light sources may be used. The amount of light that is emitted from the light sources may affect the size of the pupil 112 in relation to the size of the iris 110, which may be referred to as the dilation state of the eye 108.

Light sources with a first amount of light 104A emit light from the leftmost light source onto the eye 108. The first amount of light that is emitted from light sources with a first amount of light 104A may cause the pupil 112A to have a first dilation state 124, wherein the pupil 112A is relatively large. A dilation state may refer to the amount of dilation of the pupil 112. The camera 102 may capture one or more images of the eye 108 while the eye 108 is illuminated by light sources with a first amount of light 104A. The controller 100 may receive the captured one or more images from the camera 102. The controller 100 may be implementing a gaze tracking enrollment system.

Light sources with a first amount of light 104B emit light from the rightmost light source onto the eye 108. Light sources with a first amount of light 104B emit the first amount of light that is the same amount of light emitted by light sources with a first amount of light 104A, which may cause the pupil 112A to have the same first dilation state 124 that the light emitted by light sources with a first amount of light 104A caused. In this example, the lighting configurations of light sources with a first amount of light 104A and light sources with a first amount of light 104B have the same number of light sources illuminated, however, in some embodiments lighting configurations may have the same amount of light by varying the number and intensities of the illuminated light sources, for example, a lighting configuration that includes a single high intensity light source may have the same amount of light as a second lighting configuration that includes multiple lower intensity light sources.

The camera 102 may capture one or more images of the eye 102 while the eye 102 is illuminated by the light sources with a first amount of light 104B. The controller 100 may receive the captured one or more images from the camera 102 and may use the images in combination with the images captured while the eye 108 was illuminated by the light sources with a first amount of light 104A to determine structure information about the eye 108 with the first dilation state 124 that is caused by the first amount of light. The controller 100 may use photometric stereo techniques to determine the structure information. Structure information may include information about the iris-pupil edge, including shading information caused by the interaction of light with the surface of the eye 108 and shadow information caused by the absence of light as a result of 3D structure of the eye 108, and information about the location and surface direction of the cornea. Information about surface direction may include surface normals, which the controller 100 may determine using a trained machine learning model, and other information indicating surface direction, such as light reflections and other shading information.

Light sources with a second amount of light 106A may emit a second amount of light which causes the pupil 112B to have a second dilation state 126, wherein the pupil 112B is relatively small by relation to the iris 110. The center of vision for the eye 108 may be different in relation to the iris-pupil edge while the pupil 112B is in the second dilation state 126 compared to the pupil 112A in the first dilation state 124. Light sources with a second amount of light 106B emit the same second amount of light as light sources with a second amount of light 106A in a different lighting configuration from the lighting configuration of light sources with a second amount of light 106A. The camera 102 may capture one or more images of the eye 108 while the eye 108 is illuminated by light sources with a second amount of light 106A and the camera 102 may capture one or more images of the eye 108 while the eye is illuminated by light sources with a second amount of light 106B. The controller 100 may receive the captured images and determine structure information of the eye 108 while the pupil 112B is in the second dilation state 126.

Lighting configurations may be determined by the controller 100 based on the locations of the light sources. For example, a gaze tracking enrollment system may use light sources that are near to each other so that shadow information caused by light emitted from one light source is not unduly interfered with by light emitted from another light source. As another example, a gaze tracking enrollment system may use light sources for a second configuration that are far apart from the light sources used in a first configuration. The gaze tracking enrollment system may select distinct light sources for a second configuration compared to a first configuration to improve the amount of information available for photometric stereo techniques.

Photometric stereo techniques may include capturing images of an object at multiple lighting configurations and obtaining structure data, for example shadow information and shading information, from the images. Shadow information may include shadows that appear on a surface due to being blocked by a 3D structure. Information about the 3D structure may be determined with the position of the light relative to the camera. Shading information may include information about how light interacts with a surface, for example, the captured intensity and wavelengths of light relative to the emitted intensity and wavelengths of light. A gaze tracking enrollment system may use a trained machine learning model, such as a convolutional neural network, to obtain structure data based on the captured imaged. For example, a gaze tracking enrollment system may use a convolutional neural network to compare captured images at a same dilation state and pose to determine surface data, such as surface direction information which may include surface normals, of the eye, particularly of the cornea and iris-pupil boundary. The gaze tracking enrollment system may use the surface data determined by the convolutional neural network to generate an iris-pupil edge model and a cornea model.

A gaze tracking system, which may include the gaze tracking enrollment system, may use an iris-pupil edge model to determine the center of vision of an eye relative to the center of the pupil. A gaze tracking system may also use a cornea model to determine the location of the center of the pupil using glint tracking techniques and obtain information about the focus of the eye.

FIG. 1B is a side view of the photometric stereo enrollment system at a first illumination configuration, according to some embodiments.

To obtain information for increased accuracy gaze tracking, the controller 100 may instruct the light sources according to a first configuration 116. First configuration 116 corresponds to light sources with a first amount of light 104A, illustrated here as the individual light source 114A emitting light. The camera 102 may capture one or more images of the eye 108 as the eye 108 is illuminated by the light sources according to the first configuration 116. The controller 100 may receive the captured image illuminated with first configuration 118.

FIG. 1C is the side view of the photometric stereo enrollment system at a second illumination configuration, according to some embodiments.

The controller 100 may instruct the light sources according to a second configuration 120. Second configuration 120 corresponds to light sources with a first amount of light 104B, illustrated here as the individual light source 114B emitting light. The camera 102 may capture one or more images of the eye 108 as the eye 108 is illuminated by the light sources according to the second configuration 120. The controller 100 may receive the captured image illuminated with second configuration 122. The eye 108 may have the same dilation state when illuminated according to the first configuration 116 and the second configuration 120 because the first configuration 116 and the second configuration 120 direct the light sources to emit the same first amount of light.

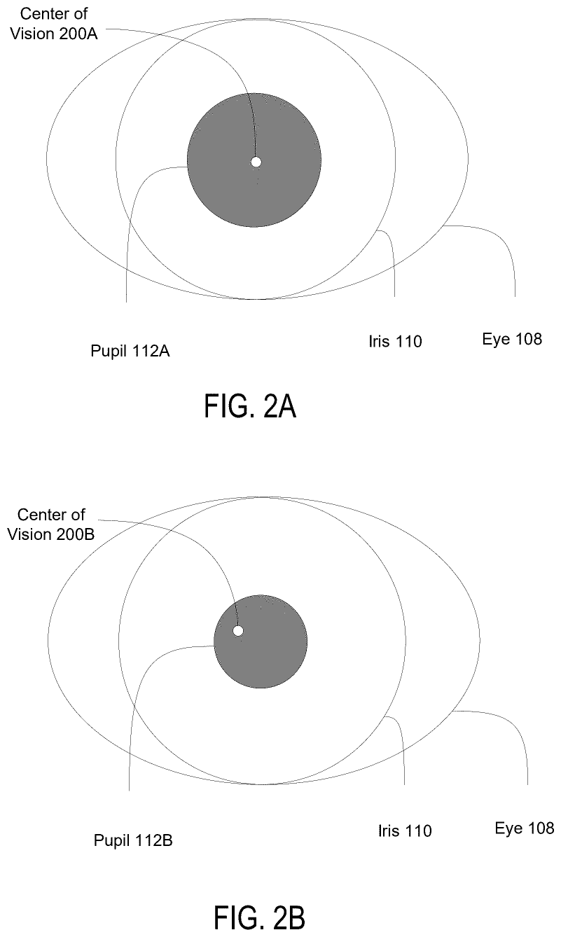

FIG. 2A illustrates an iris-pupil boundary with a known center of vision for a first dilation state of an eye, according to some embodiments.

An image captured by a camera may include associated information, such as where an indication for a user to look at is located relative to the camera. As a result, the gaze tracking enrollment system may be able to combine the associated information and the information contained in one or more images captured while an eye 108 has a particular dilation state and pose. In this example, the gaze tracking enrollment system has determined from images captured at multiple lighting configurations with the same amount of light and while the eye 108 has been directed towards a particular indicator that in this pose and dilation state where the center of vision 200A is located relative to the pupil 112A, which may be where the center of vision 200A is located relative to the iris-pupil edge. The iris-pupil edge may be the boundary between the iris 110 and the pupil 112. The iris-pupil edge may undergo changes in size and structure as a result of dilation and contraction of the pupil 112 and internal movement within the iris 110 during dilation state changes.

FIG. 2B illustrates an iris-pupil boundary with a known center of vision for a second dilation state of an eye, according to some embodiments.

In this example, the gaze tracking enrollment system has determined the relationship between the center of vision 200B and the iris-pupil boundary based on images captured at multiple lighting configurations with the same amount of light as each other and a different amount of light as the light used to capture the images that resulted in the first dilation state 124. The center of vision 200B may be known based on the location of a displayed pose indicator relative to the camera.

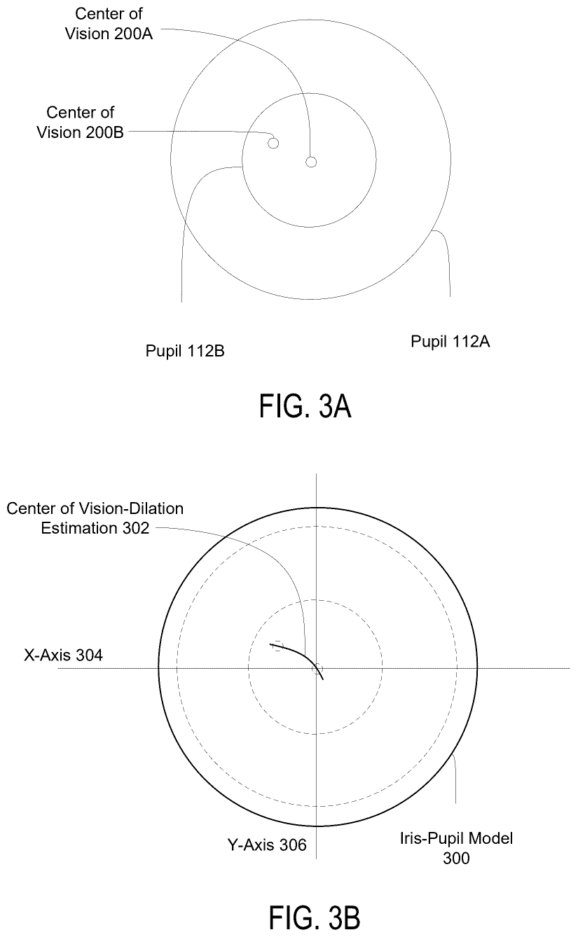

FIG. 3A illustrates the combination of the structural data of the eye contained in FIGS. 2A and 2B, according to some embodiments.

The gaze tracking enrollment system may combine information across dilation states and poses to create a model that can provide information during gaze tracking processes. In this example, information across two dilation states is shown, however, the combined information may include information across poses. In some embodiments, the gaze tracking enrollment system may use information across a different number of dilation states. The gaze tracking enrollment system may combine information such as the locations of the center of vision 200 at respective dilation states of the pupil 112. The outer edge of the pupil 112 may be the iris-pupil boundary.

FIG. 3B is an iris-pupil edge model based on the structural data illustrated in FIG. 3A, according to some embodiments.

The gaze tracking enrollment system may generate an iris-pupil model 300 based on the combined information that aligns the iris-pupil boundaries of the eye with an x-axis 304 and a y-axis 306. In some embodiments, another type of model may be used, for example, the gaze tracking enrollment system may use a model that uses a spherical structure to represent the eye.

The gaze tracking enrollment system may use determined information at multiple dilation states of the eye to estimate additional information. For example, the gaze tracking enrollment system may use the center of vision 200A corresponding to pupil 112A and the center of vision 200B corresponding to pupil 112B to generate center of vision-dilation estimation 302, which may include estimated relationships between the center of vision 200 and iris-pupil edge for dilation states of the eye other than the dilation states of pupil 112A and pupil 112B. The gaze tracking enrollment system may include information corresponding to pose of the eye in the iris-pupil model 300, for example, by including center of vision-dilation estimations for multiple poses, although not illustrated in this example. Another example of a model incorporating pose information may be a model showing center of vision-pose estimations for a particular dilation state.

During a gaze tracking process, a gaze tracking system may use the iris-pupil edge model illustrated here to determine the center of vision of the eye at the dilation state of the eye. The gaze tracking system, which may include the gaze tracking enrollment system, may cause a camera to capture an image of the eye at a current pose and dilation state, determine the eye's pose and dilation state from the captured image, and compare the information to the information contained in the iris-pupil edge model to determine a current direction of vision of the eye.

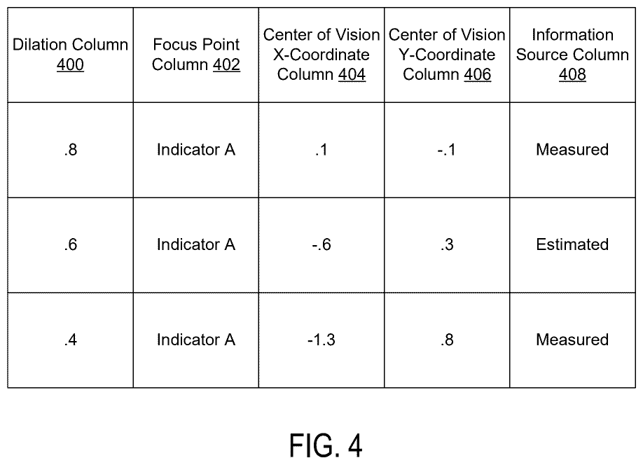

FIG. 4 is an iris-pupil edge model chart containing information that is shown visually in FIG. 3B, according to some embodiments.

The gaze tracking enrollment system may generate a model of the structure of the eye by maintaining information in a format similar to a database, wherein portions of information that are associated are displayed across rows, with the type of information being consistently located in particular columns. For example, the first row of the graph contains the names of the information stored in each column. The second, third, and fourth rows each contain information corresponding to one combination of dilation states and poses. In some embodiments, only dilation may be considered. In some embodiments only pose may be considered. The second row shown in FIG. 4 may correspond to information gathered while the eye was in a first dilation state 124 and the fourth row shown in FIG. 4 may correspond to information gathered while the eye was in a second dilation state 126. For simplicity, the shown examples have the same pose, the pose corresponding to indicator A in the focus point column 402.

The dilation column 400 indicates the dilation state for a particular portion of information. The dilation state may be determined based on the amount of light used to induce the dilation state or physical aspects of the eye, for example, the diameter of the iris-pupil edge or a ratio of the iris's radius to the pupil's radius. The focus point column 402 indicates the pose of the eye. The pose of the eye may be determined based on the active indicator point for the eye to look at, which may have a known location relative to the camera.

The center of vision x-coordinate column 404 may indicate the center of vision's position relative to the iris-pupil boundary along the x-axis of a graph model such as the model in FIG. 3B. The center of vision y-coordinate column 406 may indicate the center of vision's position relative to the iris-pupil boundary along the y-axis of a graph model such as the model in FIG. 3B. The information source column 408 may indicate whether the information in the row was obtained during enrollment or an enrollment update process carried out by the gaze tracking enrollment system, or whether the gaze tracking enrollment system estimated the information based on obtained information. Some information that is “measured” is obtained by calculation, for example, the position of the center of vision is not directly observable and depends on the location of the indicator that the eye is focused on.

In this example, the information in the third row is indicated to be estimated, meaning that the gaze tracking enrollment system did not obtain information for the combination of dilation and pose indicated in the dilation column 400 and the focus point column 402. The gaze tracking enrollment system may estimate the information in the third row based on the obtained information from the second and fourth rows.

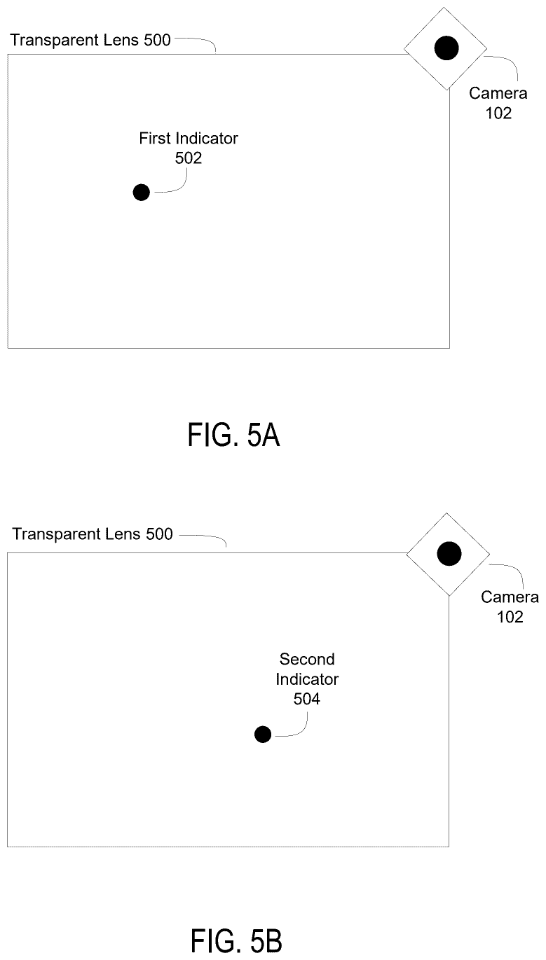

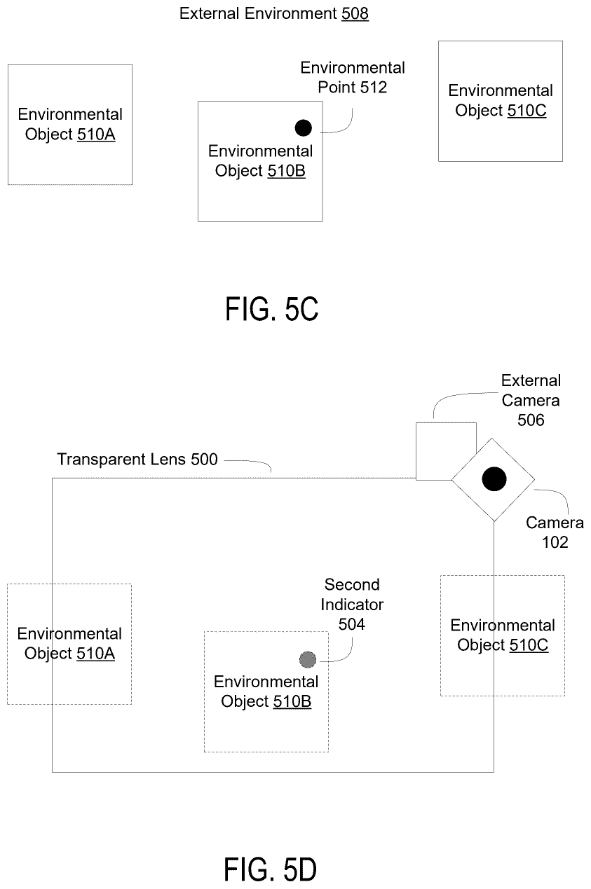

FIG. 5A is a user view of a transparent lens for display, which displays an indicator for use during photometric stereo enrollment, according to some embodiments.

A gaze tracking enrollment system may be part of a device which includes a display in front of the eyes. For example, transparent lens 500 may be a portion of a device that is located in front of a user's eye when the device is worn by the user. The user may be able to view an external environment through the transparent lens 500. The device may be configured such that digital images, for example, first indicator 502, may be displayed on the transparent lens 500 from the perspective of the user's eye. A camera 102 may be located on the device such that the camera has a known relationship to the position of the transparent lens and digital images displayed on the transparent lens.

The gaze tracking enrollment system may control the pose of the eye by displaying an indicator, such as first indicator 502, and indicating that the user should direct the center of vision of the eye to the indicator. The gaze tracking enrollment system may then cause light sources to be illuminated according to lighting configurations and cause the camera 102 to capture one or more images. Portions of the transparent lens may be light sources that are included in the lighting configuration, for example, the transparent lens 500 may display a digital image that illuminates the eye on the portions of the transparent lens 500 that are not displaying the first indicator 502. The first indicator 502 may be visually distinct from the portions of the transparent lens 500 the gaze tracking system is using as a light source. The transparent lens 500 may also include a controllable tint which the gaze tracking enrollment system may activate to lessen the amount of light passing through the transparent lens from the external environment to illuminate the eye.

FIG. 5B is a user view of the transparent lens displaying a second indicator for use during photometric stereo enrollment, according to some embodiments.

The gaze tracking enrollment system may cause the pose of the eye to change by changing the location of the displayed indicator. For example, the gaze tracking system may cause the eye to move to a new pose by removing the first indicator 502 from the transparent lens 500 and displaying the second indicator 504, which is in a different location on the transparent lens 500 relative to the camera 102. The gaze tracking enrollment system may obtain information about the eye while the eye is in the new pose with the center of vision directed to the second indicator 504 similarly to how the gaze tracking enrollment system obtained information about the eye while the center of vision was directed to the first indicator 502. A gaze tracking enrollment system may use a different number of indicators, a different type of indicators, and different locations of the indicators.

FIG. 5C is a user view of an environment the user can see during enrollment, according to some embodiments.

An external environment 508 may be a real environment where a user is located. The external environment 508 may include physical environmental objects 510 which may be located at various distances from the user. The environmental objects 510 may include visible features that are distinct from the environmental objects 510, for example, environmental object 510B includes environmental point 512. Environmental objects 510 at various distances from the user may include visually distinct environmental points 512. For example, an environmental point 512 may be a particular button on a keyboard, wherein the keyboard is an environmental object 510. As another example, an environmental point 512 may be a logo on an automobile, wherein the automobile is an environmental object 510.

FIG. 5D is a user view of the environment as seen through the transparent lens, which displays an indicator associated with the environment, according to some embodiments.

The user of a device including a gaze tracking enrollment system and transparent lens 500 may view the external environment 508 and environmental objects 510 through the transparent lens. The device may include one or more external cameras 506 which may sense environmental objects 510. The gaze tracking enrollment system may use information from the external camera 506 to detect environmental objects 510 and environmental points 512 and determine the distances from the user at which the environmental objects 510 are located.

The gaze tracking enrollment system may indicate an environmental point 512, for example by using second indicator 504 to highlight environmental point 512 on environmental object 510B. The gaze tracking enrollment system may indicate an environmental point 512 for the user to direct the center of vision of the eye to control the focus depth of the eye. The gaze tracking system may indicate an environmental point 512 to maintain user engagement in the enrollment process and increase the likelihood the center of vision of the eye is directed towards the indicated point.

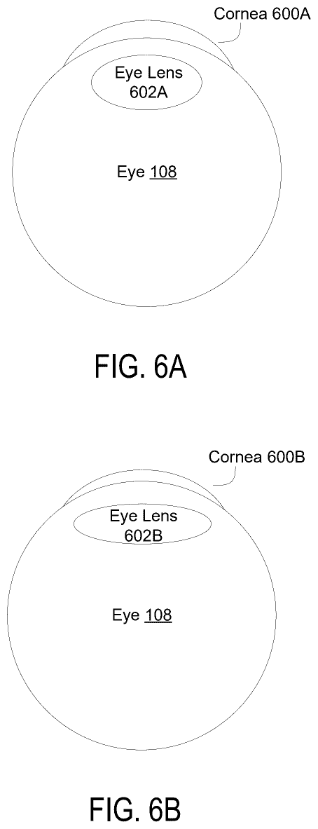

FIG. 6A is an illustration of the cornea during near-view focus, according to some embodiments.

The eye 108 illustrated in FIG. 6A has a relaxed eye lens 602A, which may indicate the focus of the eye 108 is at a near distance, for example, the eye 108 may be focused on display of a head-mounted display device. The gaze tracking enrollment system may obtain information about the state of the eye lens 602A based on the surface directions of the cornea 600A.

FIG. 6B is an illustration of the cornea during far-view focus, according to some embodiments.

The eye 108 illustrated in FIG. 6B has a flattened eye lens 602B, which may indicate the focus of the eye 108 is at a far distance, for example, the eye 108 may be focused on an environmental object. The surface directions of the cornea 600B may be flatter than the surface directions of cornea 600A. The gaze tracking enrollment system may determine surface directions of aspects of the eye by using photometric stereo techniques. In some embodiments, the gaze tracking enrollment system uses a trained machine learning model to determine surface normal of aspects of the eye.

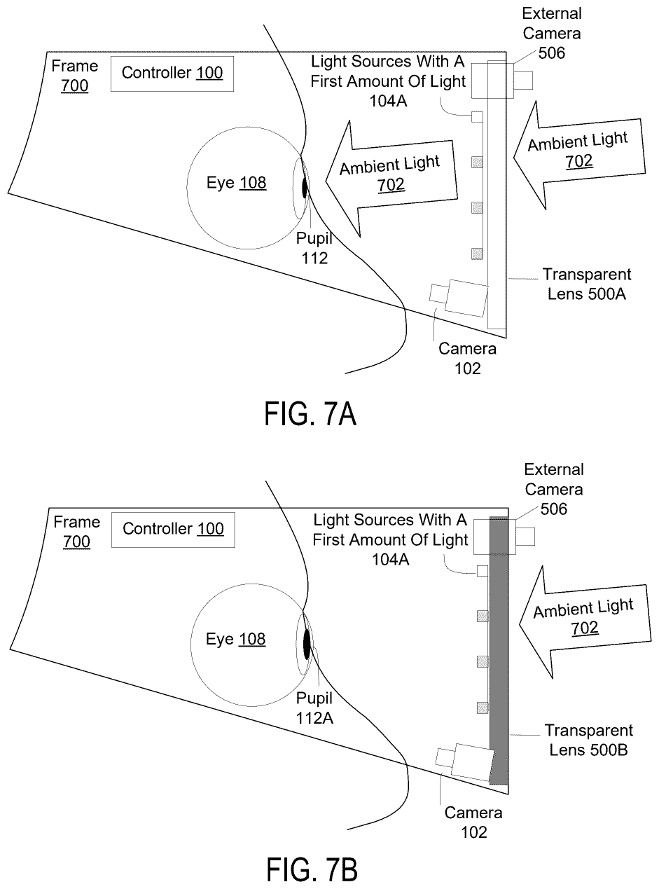

FIG. 7A is a side view of a headset-type device with a transparent lens at a first point in time, such as before a controllable tint of the transparent lens is increased, according to some embodiments.

A user may wear a device, such as a head-mounted display device, that includes a gaze tracking enrollment system. The controller 100, camera 102, light sources such as light sources with a first amount of light 104A, transparent lens 500, and external camera 506 may be associated with a frame 700 of the device. The device may be worn by a user such that the transparent lens 500 is located in front of the user's eye 108.

The transparent lens 500 may have a controllable tint which may affect the amount of ambient light 702 that reaches the eye 108 through the transparent lens 500. For example, the gaze tracking enrollment system may not have activated the controllable tint for transparent lens 500A. Ambient light 702 passes through transparent lens 500A and interacts with eye 108. The ambient light 702 adds to the light emitted by light sources with a first amount of light 104A. Ambient light 702 may be uncontrolled light which may not have a particular configuration or a consistent intensity. A gaze tracking enrollment system using photometric stereo techniques may obtain less information from images captured when ambient light 702 interacts with the eye 108 compared to when ambient light 702 does not interact with the eye 108. Additionally, ambient light may cause the pupil 112 to have an uncontrolled dilation state, which may vary depending on the intensity of the ambient light 702.

FIG. 7B is the side view of the headset-type device with the transparent lens at a second point in time, such as after the controllable tint of the transparent lens is increased, according to some embodiments.

The gaze tracking enrollment system has caused the controllable tint of transparent lens 500B to activate. A controllable tint of transparent lens 500B being active may be called a sunglasses mode of the device. With the controllable tint of transparent lens 500B active, ambient light 702 is less able to interact with the eye 108. The light emitted from the light sources with a first amount of light may be the only light interacting with the eye 108. The pupil 112A is at a dilation state corresponding to the first amount of light. The gaze tracking enrollment system may be able to obtain more useful information from images captured while the controllable tint of transparent lens 500B is active.

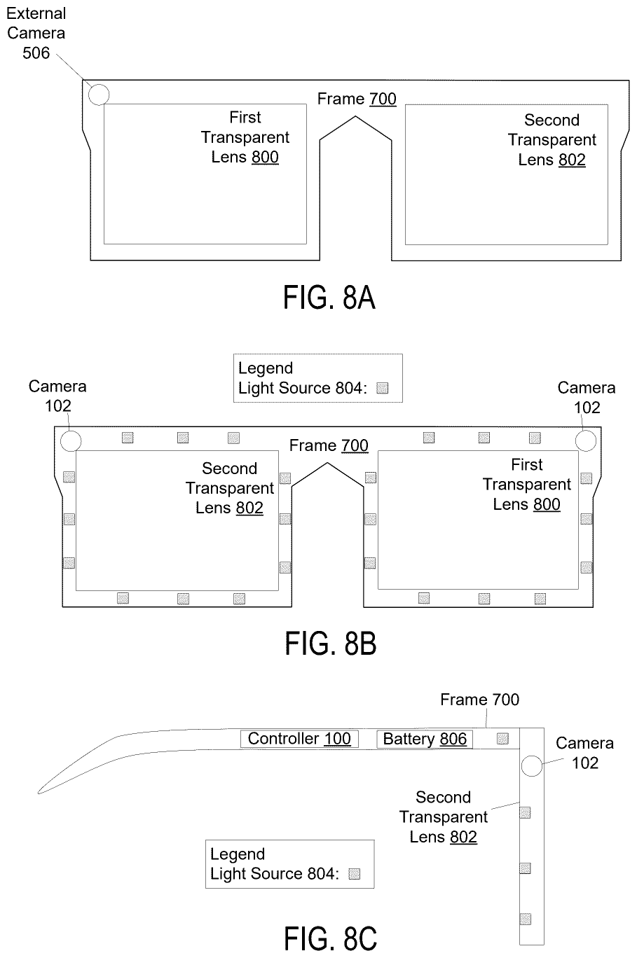

FIG. 8A is a front view of a glasses-type head-mounted display device, according to some embodiments.

A head-mounted display device may have a frame 700 similar to frames that are traditionally used for glasses and two separated transparent lenses, such as first transparent lens 800 and second transparent lens 802. A head-mounted display device such as the device shown in FIGS. 8A-8C may be called a glasses-type device. A glasses-type device may include one or more external cameras 506. Light sources and the eye-directed camera that a gaze tracking enrollment system uses may not be visible from a front view of a glasses-type device.

FIG. 8B is a back view of a glasses-type head-mounted display device, according to some embodiments.

The back view of a glasses-type device may be visible to a user of the device while the device is worn. A glasses-type device may be limited to one camera 102 per eye. Light sources 804 may be limited to locations in the frame 700, and may not be located in second transparent lens 802 or first transparent lens 800. In some embodiments, the glasses-type device may be partially rimless, for example, the frame 700 may not completely surround second transparent lens 802 and first transparent lens 800. In embodiments with partially rimless frames, the light sources 804 may also not completely surround second transparent lens 802 and first transparent lens 800 and may instead be restricted to being located on or near the frame 700.

FIG. 8C is a side view of a glasses-type head-mounted display device, according to some embodiments.

A frame 700 of a glasses-type device may include an arm, which may enable the user to wear the glasses-type device. A controller 100 and a battery 806 may be located in an arm portion of the frame 700, as shown in FIG. 8C. Light sources 804 may also be located in the arm portion of the frame 700. Light sources may be set into the frame 700 as shown in FIG. 8C, or may extend out of the frame 700 towards the face of the user while the glasses-type device is worn.

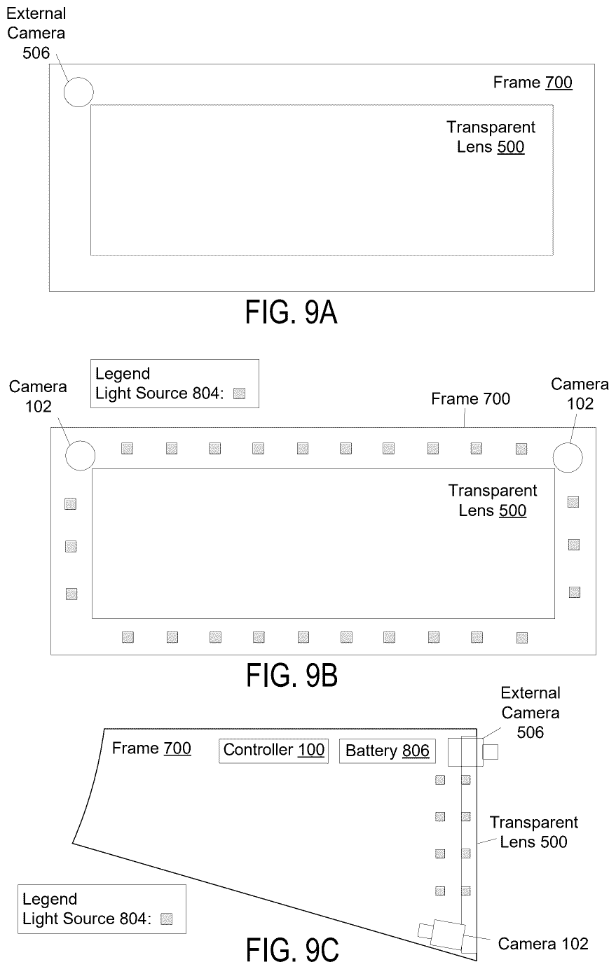

FIG. 9A is a front view of a headset-type head-mounted display device, according to some embodiments.

A head-mounted display device may have a frame 700 similar to frames that are traditionally used for headsets and a single transparent lens 500. A head-mounted display device such as the device shown in FIGS. 9A-9C may be called a headset-type device. A headset-type device may include one or more external cameras 506. Light sources and the eye-directed camera that a gaze tracking enrollment system uses may not be visible from a front view of a headset-type device.

FIG. 9B is a back view of a headset-type head-mounted display device, according to some embodiments.

The back view of a headset-type device may be visible to a user of the device while the device is worn. A headset-type device may be limited to one camera 102 per eye. Light sources 804 may be limited to locations in the frame 700, and may not be located in the transparent lens 500.

FIG. 9C is a side view of a headset-type head-mounted display device, according to some embodiments.

A frame 700 of a headset-type device may include a support portion, which may enable the user to wear the headset-type device by surrounding the user's head. A controller 100 and a battery 806 may be located in a support portion of the frame 700, as shown in FIG. 8C. Light sources 804 may also be located in the support portion of the frame 700. Light sources may be set into the frame 700 as shown in FIG. 8C, or may extend out of the frame 700 towards the face of the user while the headset-type device is worn.

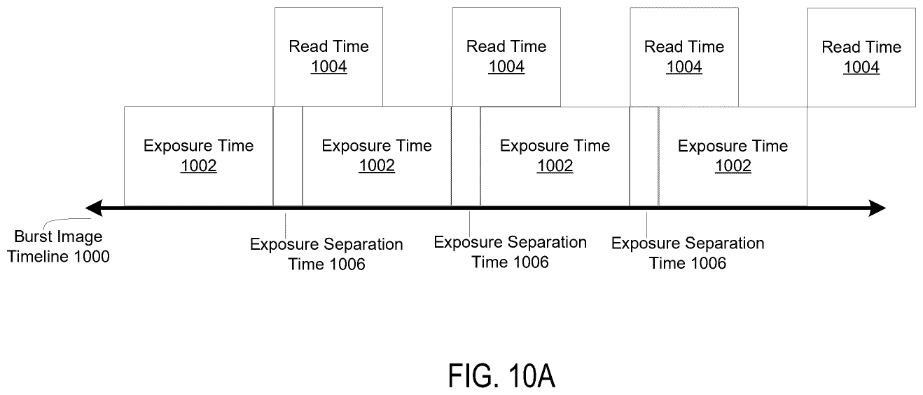

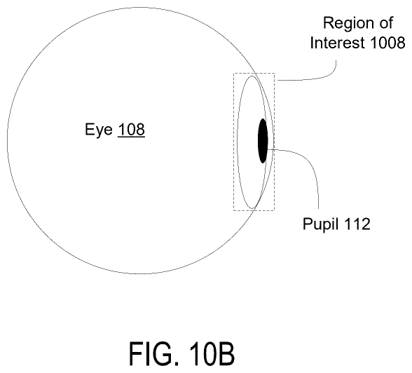

FIG. 10A is a timeline of a burst image capture, according to some embodiments.

In some embodiments, an image captured by a camera may be a burst image. A burst image may be a set of images taken during a short time period. A burst image may include more information than a non-burst image. A burst image may be captured by a process similar to the process shown on the burst image timeline 1000. A burst image may be captured by exposing a light sensor of a camera for an exposure time 1002, beginning a read time 1004 during which information captured during the exposure time 1002 is changed into retainable digital information, and carrying out an exposure separation time 1006 during which the light sensor of the camera is reset.

The read time 1004 may overlap with exposure separation time 1002 and part of a later exposure time 1002. A camera system may use integrate-while-read techniques to process a captured frame while another frame is being captured by beginning processing immediately after captured frame information is received and not stalling the camera during processing. An integrate-while-read technique may enable the camera system to capture a burst image in a shorter amount of time.

Burst image captures may be timed to minimize the impact of eye motions, for example, saccadic motion, which is not controllable. Saccadic motion occurs at approximately 50 degrees per second. A gaze tracking enrollment system may set a time during which a burst image is captured so that saccadic motion causes an amount of eye movement below a threshold, for example, one pixel of movement as captured by a camera at a known distance from the eye. A gaze tracking enrollment system may correct movement within a burst by comparing the portion of the burst image affected by blur to another portion of the burst image, for example, a frame that was captured before the frame affected by blur. For example, the gaze tracking enrollment system may determine the locations of particular reference features in one or more frames of the burst image that are not being correct, determine the same reference features in a frame that is being corrected, and align the reference features of the frame being corrected to the reference features of the one or more frames that are not being corrected.

FIG. 10B illustrates region of interest calibration, according to some embodiments.

A gaze tracking enrollment system may, prior to an image to be used for structure data information gathering being captured, calibrate a camera to focus on a region of interest 1008 of an eye 108. The region of interest 1008 may be defined by an anatomical region that the gaze tracking enrollment system is collecting structure data for, for example, the outer edge of the cornea as illustrated in FIG. 10B or the outer edge of the pupil 112. The gaze tracking enrollment system may calibrate the camera by capturing an image of the eye 108 and identifying the location of the anatomical features of interest in the image. The gaze tracking enrollment system may then direct the camera system to only process image data in the region of interest 1008. Region of interest calibration may enable processing of image data fast enough to use an integrate-while-read technique, and may decrease the time needed to capture a burst image.

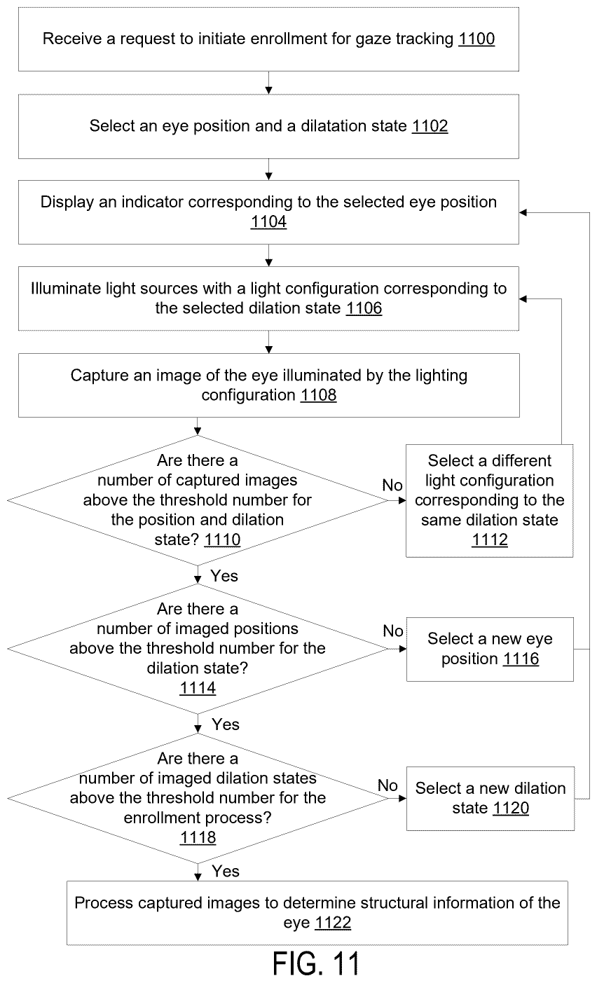

FIG. 11 is a flowchart illustrating a method of performing gaze-tracking enrollment, according to some embodiments.

At 1100, the gaze tracking enrollment system receives a request to initiate enrollment for gaze tracking. At 1102, the gaze tracking enrollment system selects an eye position, or eye pose, and a dilation state. At 1104, the gaze tracking enrollment system displays an indicator corresponding to the selected eye position. At 1106, the gaze tracking enrollment system illuminates light sources with a light configuration corresponding to the selected dilation state. In embodiments using region of interest calibration for image capturing, the gaze tracking system may capture a calibration image and determine use the calibration image to determine the region of interest immediately prior to performing step 1108. At 1108 the gaze tracking enrollment system captures an image of the eye illuminated by the lighting configuration.

At 1110, the gaze tracking enrollment system determines whether there are a number of captured images above the threshold number for the currently selected position and dilation state. If the gaze tracking enrollment system determines that the number of captured images for the position and dilation state is not above a threshold, at 1112 the gaze tracking enrollment system selects a different light configuration corresponding to the same dilation state. The gaze tracking enrollment system then returns to 1106. The threshold used may be higher than one to enable the gaze tracking enrollment system to use photometric stereo techniques.

If the gaze tracking enrollment system determines that the number of captured images for the position and dilation state is above a threshold, at 1114 the gaze tracking enrollment system determines whether there are a number of imaged positions above the threshold number for the dilation state. If the gaze tracking enrollment system determines the number of imaged positions for the dilation state is not above the threshold number, at 1116 the gaze tracking system selects a new eye position. The gaze tracking enrollment system then returns to 1104. The threshold may be a different threshold number than other thresholds used in the process.

If the gaze tracking enrollment system determines the number of imaged positions for the dilation state is above the threshold number, at 1118 the gaze tracking enrollment system determines whether the there are a number of imaged dilation states above the threshold number for the enrollment process. If the gaze tracking enrollment system determines the number of imaged dilation states for the enrollment process is not above the threshold number, at 1120 the gaze tracking enrollment system selects a new dilation state. The gaze tracking enrollment system then returns to 1104. The threshold may be a different threshold number than other thresholds used in the process. In some embodiments, the order of 1114 and 1118 may be reversed.

If the gaze tracking enrollment system determines the number of imaged dilation states for the enrollment process is above the threshold number, the gaze tracking enrollment system processes captured images to determine structural information of the eye.

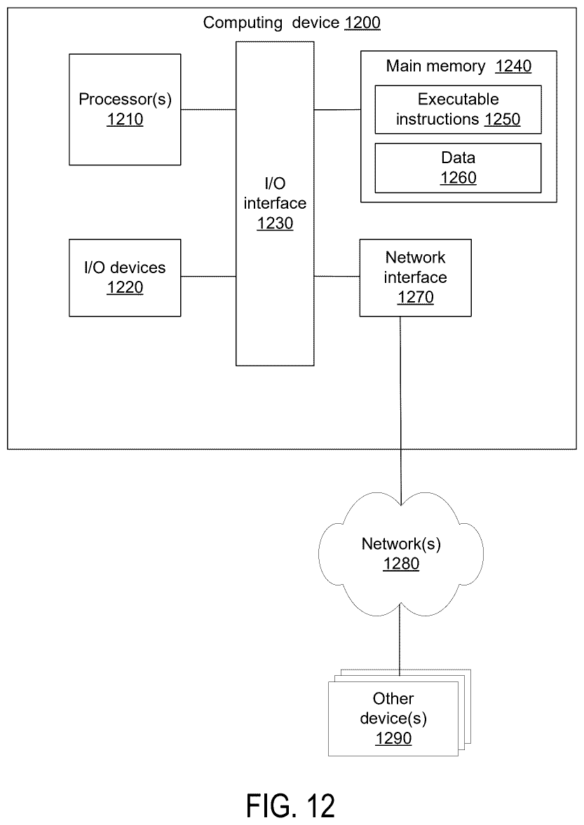

FIG. 12 is a block diagram illustrating an example computing device that may be used, according to some embodiments.

In at least some embodiments, a computing device that implements a portion or all of one or more of the techniques described herein may include a general-purpose computer system that includes or is configured to access one or more computer-accessible media. FIG. 12 illustrates such a general-purpose computing device 1200. In the illustrated embodiment, computing device 1200 includes one or more processors 1210 coupled to a main memory 1240 (which may comprise both non-volatile and volatile memory modules and may also be referred to as system memory) via an input/output (I/O) interface 1230. Computing device 1200 further includes a network interface 1270 coupled to I/O interface 1230, as well as additional I/O devices 1220 which may include sensors of various types.

In various embodiments, computing device 1200 may be a uniprocessor system including one processor 1210, or a multiprocessor system including several processors 1210 (e.g., two, four, eight, or another suitable number). Processors 1210 may be any suitable processors capable of executing instructions. For example, in various embodiments, processors 1210 may be general-purpose or embedded processors implementing any of a variety of instruction set architectures (ISAs), such as the x86, PowerPC, SPARC, or MIPS ISAs, or any other suitable ISA. In multiprocessor systems, each of processors 1210 may commonly, but not necessarily, implement the same ISA. In some implementations, graphics processing units (GPUs) may be used instead of, or in addition to, conventional processors.

Memory 1240 may be configured to store instructions and data accessible by processor(s) 1210. In at least some embodiments, the memory 1240 may comprise both volatile and non-volatile portions; in other embodiments, only volatile memory may be used. In various embodiments, the volatile portion of system memory 1240 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, executable program instructions 1250 and data 1260 implementing one or more desired functions, such as those methods, techniques, and data described above, are shown stored within main memory 1240.

In one embodiment, I/O interface 1230 may be configured to coordinate I/O traffic between processor 1210, main memory 1240, and various peripheral devices, including network interface 1270 or other peripheral interfaces such as various types of persistent and/or volatile storage devices, sensor devices, etc. In some embodiments, I/O interface 1230 may perform any necessary protocol, timing, or other data transformations to convert data signals from one component (e.g., main memory 1240) into a format suitable for use by another component (e.g., processor 1210). In some embodiments, I/O interface 1230 may include support for devices attached through various types of peripheral buses, such as a variant of the Peripheral Component Interconnect (PCI) bus standard or the Universal Serial Bus (USB) standard, for example. In some embodiments, the function of I/O interface 1230 may be split into two or more separate components, such as a north bridge and a south bridge, for example. Also, in some embodiments some or all of the functionality of I/O interface 1230, such as an interface to memory 1240, may be incorporated directly into processor 1210.

Network interface 1270 may be configured to allow data to be exchanged between computing device 1200 and other devices 1290 attached to a network or networks 1280, such as other computer systems or devices. In various embodiments, network interface 1270 may support communication via any suitable wired or wireless general data networks, such as types of Ethernet network, for example. Additionally, network interface 1270 may support communication via telecommunications/telephony networks such as analog voice networks or digital fiber communications networks, via storage area networks such as Fibre Channel SANs, or via any other suitable type of network and/or protocol.

In some embodiments, main memory 1240 may be one embodiment of a computer-accessible medium configured to store program instructions and data as described above for FIG. 1 through FIG. 11 for implementing embodiments of the corresponding methods and apparatus. However, in other embodiments, program instructions and/or data may be received, sent, or stored upon different types of computer-accessible media. Generally speaking, a computer-accessible medium may include non-transitory storage media or memory media such as magnetic or optical media, e.g., disk or DVD/CD coupled to computing device 1200 via I/O interface 1230. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 1200 as main memory 1240 or another type of memory. Further, a computer-accessible medium may include transmission media or signals such as electrical, electromagnetic, or digital signals, conveyed via a communication medium such as a network and/or a wireless link, such as may be implemented via network interface 1270. Portions or all of multiple computing devices such as that illustrated in FIG. 12 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system, comprising:
a controller;
a camera; and
a plurality of light sources configured to emit light directed at an eye, wherein one or more individual ones of the light sources are configured to be controlled separately;
wherein the controller is configured to:
cause the camera to capture a first plurality of respective images of the eye while the light sources emit light according to a first plurality of respective configurations, each resulting in a first amount of light that causes the eye to have a first dilation amount;
cause the camera to capture a second plurality of respective images of the eye while the light sources emit light according to a second plurality of respective configurations, each resulting in a second amount of light that causes the eye to have a second dilation amount; and
determine structure data of the eye based on the first and second plurality of respective images.

2. The system of claim 1, wherein the determined structure data of the eye based on the first and second plurality of images is an iris-pupil edge model for a plurality of dilation amounts, wherein the iris-pupil edge model indicates a respective center of vision for respective ones of the plurality of dilation amounts.

3. The system of claim 2, wherein the controller is further configured to:
cause the camera to capture an additional image of the eye; and
determine a direction of vision of the eye based on the additional image and the iris-pupil edge model.

4. The system of claim 1, wherein the determined structure data of the eye based on the first and second plurality of images further comprises a cornea model.

5. The system of claim 1, wherein:
the controller is further configured to cause a first indicator to be displayed that causes the eye to have a first pose;
in the first pose, vision of the eye is in a first known direction; and
the first indicator is displayed while the camera captures the first and second pluralities of respective images.

6. The system of claim 5, wherein:
the controller is further configured to cause a second indicator to be displayed that causes the eye to have a second pose;
in the second pose, the vision of the eye is in a second known direction;
the controller is further configured to further cause the camera to capture additional ones of the first and second pluralities of respective images; and
the second indicator is displayed while the camera further captures additional ones of the first and second pluralities of respective images.

7. The system of claim 6, wherein:
the system further comprises one or more transparent lenses and one or more external cameras;
the first indicator is displayed on the one or more transparent lenses, wherein the one or more transparent lenses are at a first depth;
the one or more external cameras identify a point at a second depth; and
the second indicator is displayed by an indication of the point identified by the one or more external camera at the second depth.

8. The system of claim 1, wherein:
the system further comprises one or more transparent lenses, wherein the one or more transparent lenses have a controllable tint; and
the controller is further configured to increase the tint of the one or more transparent lenses to minimize ambient light sources while the camera captures the first and second pluralities of respective images.

9. The system of claim 1, wherein the first and second pluralities of images comprise one or more burst images, wherein a burst image is a set of images that are captured within a threshold period of time relative to each other.

10. The system of claim 9, wherein the one or more burst images are captured using one or more of:
an integrate-while-read image capture technique; and
region of interest calibration.

11. The system of claim 9, wherein the program instructions, when executed on or across the one or more processors, further cause the one or more processors to:
correct for motion in a particular burst image using reference features of the eye.

12. The system of claim 1, wherein the system further comprises a head-mounted display device, and wherein the controller, the camera, and the plurality of light sources are components of the head-mounted display device.

13. A method, comprising:
causing a camera to capture a first plurality of respective images of an eye, while light sources of a plurality of light sources emit light according to a first plurality of respective configurations, each resulting in a first amount of light that causes the eye to have a first dilation amount;
causing the camera to capture a second plurality of respective images of the eye while the light sources emit light according to a second plurality of respective configurations, each resulting in a second amount of light that causes the eye to have a second dilation amount; and
determining structure data of the eye based on the first and second plurality of respective images.

14. The method of claim 13, wherein the determined structure data based on the first and second plurality of respective images is an iris-pupil edge model for a plurality of dilation amounts, wherein the iris-pupil edge model indicates a respective center of vision for respective ones of the plurality of dilation amounts.

15. The method of claim 14, further comprising:
causing the camera to capture an additional image of the eye; and
determining a direction of vision of the eye for the additional image based on the additional image of the eye and the iris-pupil edge model.

16. The method of claim 13, further comprising:
causing a first indicator to be displayed that causes the eye to have a first pose, wherein, in the first pose, vision of the eye is in a first known direction; and
causing the first indicator to be displayed while the camera captures the first and second pluralities of respective images.

17. The method of claim 13, further comprising:
causing a second indicator to be displayed that causes the eye to have a second pose, wherein, in the second pose, the vision of the eye is in a second known direction;
causing the camera to further capture additional ones of the first and second plurality of respective images; and
causing the second indicator to be displayed while the camera further captures additional ones of the first and second pluralities of respective images.

18. The method of claim 13, further comprising increasing a tint of one or more transparent lenses, wherein the tint of the one or more transparent lenses is controllable, to minimize ambient light.

19. A non-transitory computer-readable storage media storing program instructions that, when executed on or across one or more processors, cause the one or more processors to:
cause a camera to capture a first plurality of respective images of an eye, while light sources of a plurality of light sources emit light according to a first plurality of respective configurations, each resulting in a first amount of light that causes the eye to have a first dilation amount;
cause the camera to capture a second plurality of respective images of the eye while the light sources emit light according to a second plurality of respective configurations, each resulting in a second amount of light that causes the eye to have a second dilation amount; and
determine structure data of the eye based on the first and second plurality of respective images.

20. The computer-readable storage medium of claim 19, wherein the determined structure data based on the captured images is an iris-pupil edge model for a plurality of dilation amounts, wherein the iris-pupil edge model indicates a respective center of vision for respective ones of the plurality of dilation amounts.
